(19) United States
(12) Patent Application Publication
(10) Pub. No.: US 2022/0364606 A1
(43) Pub. Date: Nov. 17, 2022

(54) THREADED TAPERED FASTENER FOR SECURING A POWER TRANSMISSION DEVICE TO A SHAFT

(71) Applicant: AGCO Corporation, Duluth, GA (US)

(72) Inventors: JEFFERY A. BALDAUF, Hesston, KS (US); BRODY O. BUZZARD, Hesston, KS (US)

(21) Appl. No.: 17/663,209

(22) Filed: May 12, 2022

Related U.S. Application Data
(60) Provisional application No. 63/188,073, filed on May 13, 2021.

(51) Int. Cl. F16D 1/08

(52) U.S. Cl. CPC F16D 1/0847; F16B 19/02

(57) ABSTRACT

A working machine assembly has a rotatable shaft and a power transmission device having a central hub with a bore there through configured to receive the rotatable shaft. The shaft and power transmission device are connected with a securing mechanism that includes a key inserted in a keyway formed in an inner surface of the central hub and a key seat formed along a portion of the shaft wherein the key prevents relative movement between the rotatable shaft and the attached power transmission device. The securing mechanism has a pin having a flat tapered surface. The pin is received in a cross hole in the hub and interacts with the key such that the tapered surface abuts the key. The pin has a threaded end. A nut is received on the threaded end and used to draw the tapered surface of the pin against the key in a wedging action.

### CROSS-REFERENCE TO RELATED APPLICATIONS

This application claims the benefit of and priority from U.S. Application No. 63/188,073, filed May 13, 2021, the entire disclosure of each of which is hereby incorporated by reference.

### BACKGROUND OF THE INVENTION

### Field of Invention

This invention relates to a threaded tapered fastener for securing a power transmission device to a shaft

### Description of Related Art

Working machines, such as commonly found in on agricultural industry, use various methods to couple power transmission devices, such as pulleys, sprockets, and the like, onto shafts to transfer rotational energy. Square or rectangular keys are often placed in adjacent grooves to lock the hub of the transmission device and shaft rotation together. However, axial displacement of hub can occur unless the components are locked in place by an extra component. Over time keyed joint might become very difficult to dismantle, can introduce stress points due to notch effect and reduce shaft strength, and can introduce shaft imbalance.

Several different means have been used to hold the key in place. For example, threaded set screws are often used to secure the key and hub position. However, in extreme applications with vibration or load reversal, the set screws can work loose and allow the key and/or hub to move. The use of set screws also can cause deformation of shafts in localized areas. Gib head keys have also been used, with the head of the key serving as a concussion point for hammering the key into place without damage to the shaft of the key. However, tight operating conditions can make it difficult to set the gib key properly, and therefore, it is not always done correctly. This can lead to the loss of the key/device during the course of normal operation.

Therefore, it is desired to have improved means to secure power transmission devices to a keyed shaft without the necessity to clamp through the ends of the device and that can be implemented in locations that may be limited in available space.

### OVERVIEW OF THE INVENTION

In one embodiment, the invention is directed to a working machine assembly having a rotatable shaft and a power transmission device having a central hub with a bore there through configured to receive the rotatable shaft. The shaft and power transmission device are connected with a securing mechanism. The securing mechanism includes a key inserted in a keyway formed in an inner surface of the central hub and a key seat formed along a portion of the shaft wherein the key prevents relative movement between the rotatable shaft and the attached power transmission device. The securing mechanism has a pin having a flat tapered surface on at least one side of the pin, wherein the pin is received in a cross hole in the hub and interacts with the key such that the tapered surface of the pin abuts the key, wherein the pin has a distal threaded end, and wherein the flat tapered surface is formed in a middle portion of the pin between the threaded end and a proximal end of the pin. A nut is received on the threaded end of the pin and used to draw the tapered surface of the pin against the key in a wedging action.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is an exploded perspective view of a power transmission device mounted on a shaft with a securing mechanism;

FIG. 2 is an elevation view of the power transmission device and securing mechanism of FIG. 1;

FIG. 3 is a sectional view of the securing mechanism of FIG. 1; and

FIG. 4 is a side view of the securing mechanism of FIG. 1.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

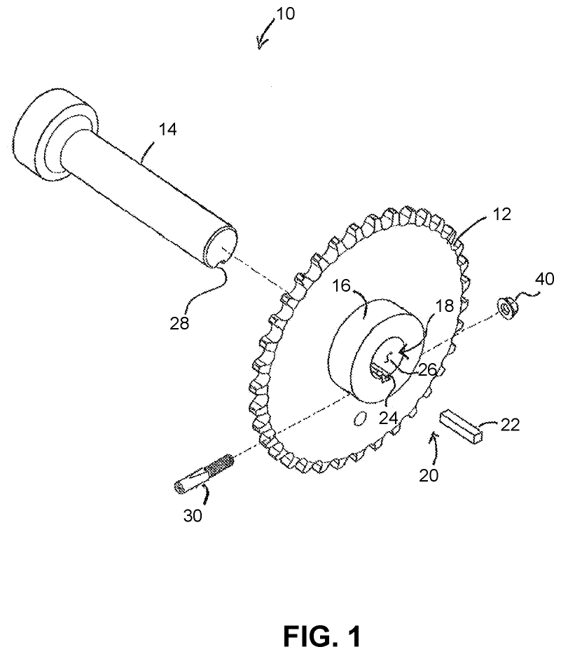

Turning to the figures, wherein like reference numerals represent like elements throughout the several views, FIG. 1 illustrates a working machine assembly 10 having a power transmission device 12 that is mounted on a rotatable shaft 14. One skilled in the art will understand that the shaft 14 may be powered by a suitable power source (not shown) such as an engine, electric motor, hydraulic motor or any other known power source. Furthermore, the power transmission device 12 may be any one of a gear drive, pulley, sprocket or other known power transmission component. The power transmission device 12 has a central hub 16 with a bore 18 there through configured to receive the shaft 14. A securing mechanism 20 holds the power transmission device 12 tightly on the shaft 14 so that relative movement between or even separation of the components of the working machine assembly 10 caused by vibration or load reversal is discouraged.

The securing mechanism 20 includes a keyed joint having a key 22 that is inserted or mounted between the shaft 14 and the central hub 16 in an axial direction to prevent relative movement between the components. The key 22 is received in a keyway 24 formed in an inner surface 26 of the central hub 16 and a key seat 28 formed along a portion of the shaft 14 to prevent relative movement between the rotatable shaft 14 and the attached power transmission device 12. The key 22 can have a square, rectangular or other suitable shape using sound engineering judgment. The key seat 28 and hub keyway 24 may be cut using known key seating machines or any other broaching, milling, shaping, or slotting electric discharge machining (EDM) process.

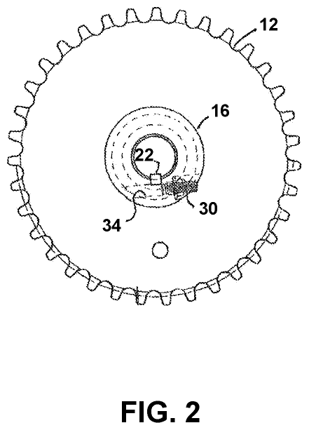

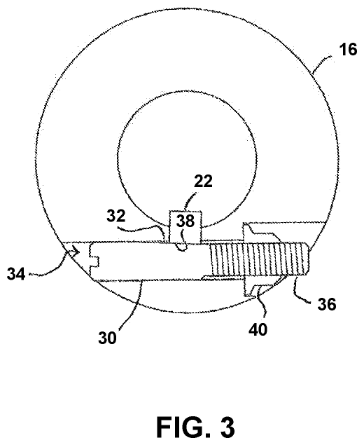

According to the invention, the securing mechanism 20 also includes a threaded pin 30 with a flat tapered surface 32 on at least one side of the pin 30. As best seen in FIG. 2, the hub 16 is machined to include a cross hole 34 configured to receive a distal threaded end 36 of the pin 30 and allow the pin 30 to engage an outer surface 38 of the key 22. The cross hole 34 is used to locate the pin 30 such that the tapered surface 32 of the pin 30 abuts the key 22. Turning also now to FIG. 3, a nut 40 is received on the threaded end 36 of the pin 30 and is used to draw the pin 30 tight against the key 22. Desirably, the distal threaded end 36 has a length X that makes up about 25% to about 50% of an overall length of the pin 30. The flat tapered surface 32 is formed in a middle portion 42 of the pin 30 between the distal threaded end 36 and a proximal end 44 of the pin 30. A diameter of the cross hole 34 is sized such that the threaded distal end 36 of the pin 30 is readily received through the hole 34 but the tapered surface 32 in the middle portion 42 engages the key 22. The wedging action of the pin 30 against the key 22 caused by the tapered surface 32 being forced against the key 22 desirably maintains a secure joint that is less likely to come loose in severe duty applications.

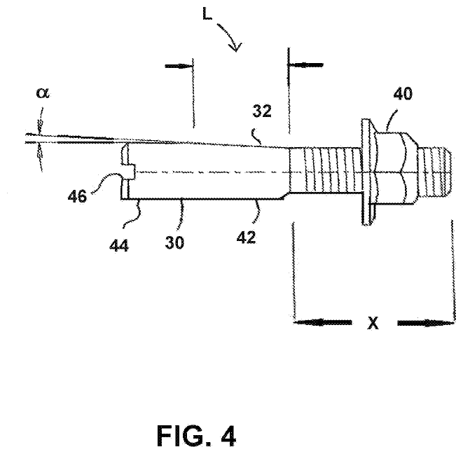

Referring to FIG. 4, the tapered surface 32 of the pin 30 may have a taper of between 1 in 50 and 1 in 150, and more desirably about 1 in 100 along the length of the tapered middle portion of the pin 30, such that an angle α is measured between the tapered surface 32 and the non-tapered proximal end 44 of the pin 30. In one embodiment, the pin 30 includes a locating component 46 to aid with visual indication of the orientation of the tapered surface 32 of the pin 30. In the illustrated embodiment, the locating component 46 is a slot in the proximal end 44 of the pin 30 that aids installation and provides means to rotate the pin 30 if necessary.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A working machine assembly having a rotatable shaft and a power transmission device having a central hub with a bore there through configured to receive the rotatable shaft, the shaft and power transmission device being connected with a securing mechanism, the securing mechanism comprising:
a key inserted in a keyway formed in an inner surface of the central hub and a key seat formed along a portion of the shaft wherein the key prevents relative movement between the rotatable shaft and the attached power transmission device;
a pin having a flat tapered surface on at least one side of the pin, wherein the pin is received in a cross hole in the hub and interacts with the key such that the tapered surface of the pin abuts the key, wherein the pin has a distal threaded end, and wherein the flat tapered surface is formed in a middle portion of the pin between the threaded end and a proximal end of the pin; and
a nut received on the threaded end of the pin and used to draw the tapered surface of the pin against the key in a wedging action.

2. The working machine assembly of claim 1 wherein the distal threaded end has a length that makes up between 25% to 50% of an overall length of the pin.

3. The working machine assembly of claim 1 wherein the pin includes a locating component providing a visual indication of the orientation of the tapered surface of the pin.
